(19) United States
(12) Patent Application Publication
(10) Pub. No.: US 2007/0283576 A1
(43) Pub. Date: Dec. 13, 2007

(54) Cutting tool for composition shingles

(76) Inventor: Albert Saiz, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/448,358

(22) Filed: Jun. 7, 2006

(51) Int. Cl. B26B 29/00

(52) U.S. Cl. 30/294

(57) ABSTRACT

An improved cutting tool for cutting asphalt composition shingles that are commonly utilized as a roofing material. In the preferred embodiment, the cutting tool has a handle section with a hand grippable handle, a head section with a head body attached at one end of the handle, a cutting blade pivotally attached to the head body and a vibrating mechanism disposed in the head body to vibrate the cutting blade so as to cut composition shingles faster and with less effort. The cutting blade can have one or more cutting edges for rearward or forward direction cutting. The vibrating mechanism can be disposed in the handle and can comprise an pneumatically or electrically powered motor that drives an eccentric weight. The head body and handle can be integral. One or more batteries disposed in the handle can provide electrical power to the electric motor.

### CROSS-REFERENCE TO RELATED APPLICATIONS

None.

### BACKGROUND OF THE INVENTION

A. Field of the Invention

The field of the present invention relates generally to tools utilized in commercial and residential roofing. More particularly, the present invention relates to such cutting tools that are specifically configured to cut composition shingles. Even more particularly the present invention relates to such cutting tools that have a vibratory apparatus to vibrate the cutting blade.

B. Background

Various roofing materials are utilized as the outer, environmental barrier on roofs throughout the world. The most common type of roofing material utilized in the United States and Canada are asphalt-based shingles, which are commonly referred to as composition roofing shingles or composition shingles due to the combination of materials used for the shingles. The most common types of composition shingles comprise a tough reinforcing membrane or fabric, which is typically either a fiberglass-based mat or an organic felt, that is covered or impregnated with one or more layers of asphalt and/or asphalt mixtures. In some areas of the country, particularly those in hot and humid areas, zinc or copper granules are applied to the fiberglass mat or organic felt to protect against the growth of algae. Modified asphalt composition shingles utilize a rubber modifier, such as Styrene or Polypropylene based material, to enhance flexibility, durability, crack resistance, impact resistance and resistance to ultraviolet light. Historically, the most common type of a composition shingle has been the three-tab shingle. A more modern type of shingle, commonly referenced as architectural laminated shingles, is an asphalt composition shingle having a textured look designed to simulate wood, concrete or slate in order to provide a much less expensive alternative to the “real” material. Composition shingles were originally sold as having a 15 year life. Today, most composition shingles are marketed as having a minimum of a 20 year life, with some manufactures offering composition shingles having a 30 to 50 year estimated life, such as those sold under the Grand Sequoia® and Presidential® brands. One of the primary differences between the lower and longer life shingles is the thickness of the shingles, particularly with regard to the longest life shingles, which can have three layers of shingles combined together into one shingle.

During the installation of a roof having composition shingles it is necessary to cut the shingles to the size and shape necessary for the layout of the roof. The typical cutting tool for composition shingles is a hand-held utility knife, usually of the type having a retractable blade that extends from or retracts into the knife handle. Over the years, the knife utilized by roofers has evolved from the common straight edged blade utility knife to one having a hooked or notched shaped blade portion to better get under and cut through composition shingles. These speciality utility knives are commonly referred to as composition or roofers knives. One common configuration for composition knives utilizes a carbon hook utility blade having a pair of facing hook portions separated by a center mounting hole that allows the user to swap ends of the blade when one of the hook portions becomes dull due to use. Another common configuration is referred to as a bow-tie roofer blade, which has a pair of generally V-notched cutting sections at each end separated by the center mounting hole. Although they require manual application of sufficient force to cut through the composition shingles, both types of knives have worked generally well for many years. The main problem with composition knives is that the asphalt material in the composition shingles tends to bunch or clog up around the blade's hook or notch section, thereby making further cutting difficult. With the advent of the thicker, longer life composition shingles (i.e., those having an estimated useful life of 30 or more years), it has become even more difficult to cut the shingles with the standard, hand-held composition knife.

Over the years, various people have developed improved shingle cutting tools for cutting composition shingles. For instance, U.S. Pat. No. 2,914,851 to Rogers describes a shingle cutter that is configured as a pistol-grip type of device that has cutter blade which pivots between a pair of horizontal legs to cut a shingle when the user squeezes the grip member towards the handle. U.S. Pat. No. 4,821,609 to Rushbrook describes a shingle cutting tool having a cutting body, made from a flat plate made from hardened steel, that is attached to an elongated handle. The cutting body has a pair of opposite directed V-shaped notches having sharpened cutting edges. The notches face in opposite directions to allow the user to push or pull the tool across the shingles to cut them. U.S. Publication No. 2004/0128836 to Garrett describes a shingle cutting tool that is alternatively shown as a miniaturized reciprocating saw, a miniaturized circulating saw and a standard hook-configured composition knife adapted to receive compressed air to move the blade in a reciprocating motion. Although the reciprocating motion of the composition knife version of the Garrett reference appears to reduce the need for the user to pull the knife through the composition shingle, in reality the tool would likely have the same problem with regard to the asphalt material clogging the hook portion of the blade while the user attempts to pull or push the blade through the shingles. U.S. Publication No. 2005/0204652 to Schafer describes a shingle cutting device having one or more hooked cutting blades which are attached to a base section with a C-shaped channel that is configured to fit over and slidably engage an upwardly extending ridge on a roof to cut the section of the shingles in a roof valley.

None of the foregoing prior art devices is much of an improvement over the results achieved with the standard composition knife with regard to being able to more easily and quickly cut composition shingles, particularly the thicker composition shingles. What is needed, therefore, is an improved cutting tool for cutting composition shingles. The preferred cutting tool should be configured to more easily and quickly cut through composition roofing shingles, even the more modern thicker shingles, with minimum effort exerted by the user. Preferably, the improved cutting tool would be configured to be a hand-held tool that utilizes cutting blades of the type that are currently available. The preferred cutting tool should be adapted to be powered by air supplied through an air hose or by electrical power, whether attached to a cord or cordless.

### SUMMARY OF THE INVENTION

The cutting tool for composition shingles of the present invention solves the problems and provides the benefits identified above. That is to say, the present invention discloses a new and improved cutting tool that more easily and quickly cuts through composition shingles, including the new thicker shingles, than the commonly utilized composition knife and the other prior art shingle cutting tools. In the preferred embodiment, the improved shingle cutting tool of the present invention comprises an air or electrical, whether of the cord or cordless type, powered vibrating mechanism to vibrate the cutting blade so as to cut through composition shingles of all types with a minimum amount of physical cutting effort by the user. The preferred cutting tool is sized and configured to comfortably fit in the user's hand and to utilize standard, replaceable hook or notched cutting blades. The cutting tool preferably utilizes a rotatable, double-sided cutting blade that allows the user to quickly change the use of the cutting tool from one that is pulled through the composition shingle during cutting to one that is pushed through during cutting.

In one general aspect of the present invention, the cutting tool for cutting asphalt composition shingles comprises a tool housing that includes a handle section and a head section, a cutting blade that is attached to the tool housing, the cutting blade having one or more cutting edges, and a vibrating mechanism that is associated with the tool housing for vibrating the cutting blade so as to more easily and quickly cut composition shingles to their desired size and configuration. In the preferred embodiment, the cutting blade has at least two cutting edges and it is pivotally attached to a head body in the head section so as to allow the user to selectively place the cutting blade in position for cutting in a rearward/pulling direction or a forward/pushing direction. Preferably, the head section is separate from but attached to one end of an elongated handle that comprises the handle section so as to reduce the amount of vibration where the tool is held by the user when cutting composition shingles. If desired, a dampening member can be disposed between the head and handle sections to further reduce vibration at the handle. In alternative embodiments, the head and handle sections are integral and the vibrating mechanism is disposed in the integral component or the vibrating mechanism is disposed in the separate handle section. The vibrating mechanism can comprise a pneumatically powered motor with a pneumatic connector provided to connect to a pneumatic line. An air regulating control valve can be utilized to allow the user to regulate the flow of air to the motor so as to control the amount of vibration. In an alternative embodiment, the vibrating mechanism comprises an electric motor that is either powered by batteries disposed in the handle section or by a cord that connects to an outlet or other source of electrical power. In the preferred configuration, the cutting tool is configured to be a relatively small, hand-held device that can be quickly deployed to cut composition shingles when needed or desired. Standard hook blades or bow-tie blades can be utilized with the cutting tool. In use, the cutting blade is locked into its desired position, the vibrating mechanism is activated, the user places the cutting edge against the composition shingles at the place where he or she desires to cut it and then the user directs the cutting blade along the cutting path. The vibration of the cutting blade will make it much easier and faster for the user to cut the shingles Accordingly, the primary objective of the present invention is to provide a cutting tool for composition shingles that provides the advantages discussed above and overcomes the disadvantages and limitations associated with presently available shingle cutting tools.

It is also an important object of the present invention to provide a cutting tool for composition shingles that utilizes a vibrating mechanism to vibrate the cutting blade so as to more easily and quickly cut the composition shingles with a minimum amount of cutting effort exerted by the user.

It is also an important object of the present invention to provide a cutting tool for composition shingles that has an air or electrically powered vibrating mechanism that vibrates all or a portion of the cutting tool so as to vibrate the cutting blade as it moves through the shingles so as to substantially reduce the amount of physical force required from the user.

It is also an important object of the present invention to provide a cutting tool for composition shingles that comprises a dual cutting edge, rotatable cutting blade that allows the user to use the cutting tool in a pull or push through manner for cutting composition shingles.

It is also an object of the present invention to provide a cutting tool for composition shingles that is hand-held and utilizes commonly available, replaceable hook-shaped or notched cutting blades.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is side view of a cutting tool for cutting composition shingles configured according to a preferred embodiment of the present invention showing the head portion attached to the handle, the cutting blade configured for pulling the tool through the composition shingles and the tool configured for attachment to a supply of compressed air;

FIG. 2 is a side view of the cutting tool for composition shingles of FIG. 1 showing use of batteries to supply power to the vibrating mechanism and the cutting blade configured for pushing the tool through the composition shingles;

FIG. 3 is a side view of the cutting tool of FIG. 2 showing use of an electric cord to supply power to the vibrating mechanism;

FIG. 4 is a side view of an alternative embodiment of the cutting tool for composition shingles of the present invention showing the vibrating mechanism incorporated into a vibrating housing so as to vibrate the notched cutting blade; and

FIG. 5 is a side view of the head section showing the components of the vibrating mechanism disposed therein.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are directed to a hand-held tool, those skilled in the art will readily understand that this is merely for purposes of simplifying the present disclosure and that the present invention is not so limited, as the present invention is equally applicable for use with a tool mounted on a long handle or another apparatus.

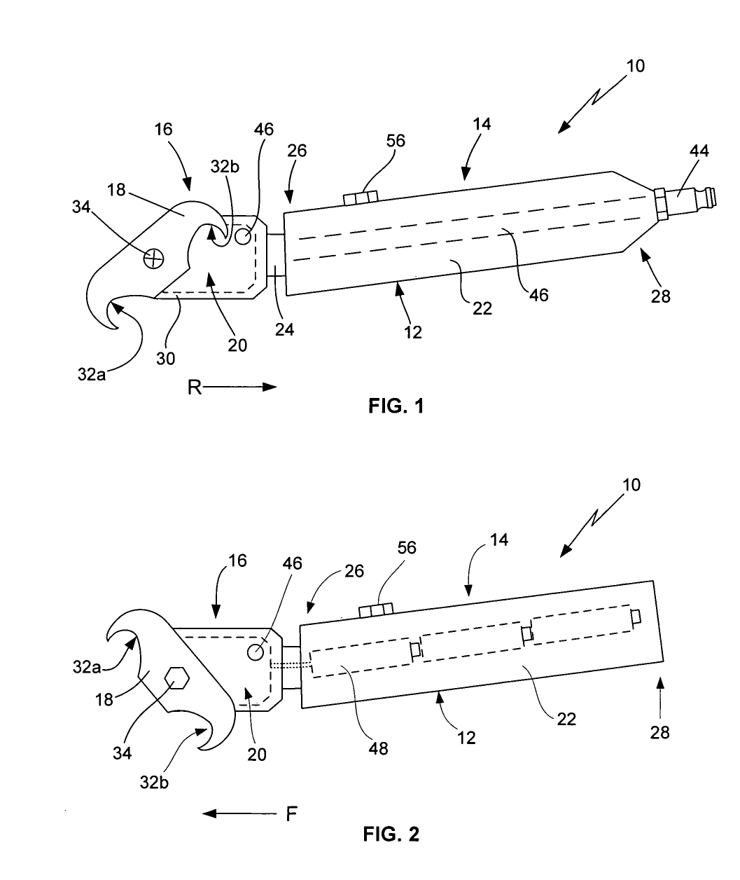

A cutting tool that is manufactured out of the components and configured pursuant to a preferred embodiment of the present invention is shown generally as 10 in the figures. Cutting tool 10 generally comprises a tool housing 12 having a handle section 14 and a head section 16, a cutting blade 18 and a vibrating mechanism 20 associated with the tool housing 12 for imparting a vibration motion to cutting blade 18. In the preferred configuration, shown in FIGS. 1 through 3, handle section 14 and head section 16 are separate components that are joined together with the vibrating mechanism 20 disposed inside head section 16. In an alternative embodiment, shown in FIG. 4, handle section 14 and head section 16 are integral such that tool housing 12 is a unitary housing member with vibrating mechanism 20 disposed inside tool housing 12. The primary benefit of having handle section 14 separate from, but connected to, head section 16 is to reduce the vibration at elongated handle 22, which is the part of cutting tool 10 held by the user during use. In other embodiments, vibrating mechanism 20 can be disposed inside handle section 14 or attached externally to the outer surface of tool housing 12 (i.e., disposed inside a separate housing component). As explained in more detail below, vibrating mechanism 20 is configured to impart vibration to cutting blade 18 so as to cut composite shingles faster and easier than with prior art shingle cutting tools. Because the vibration of cutting blade 18 must be of sufficient intensity to assist cutting blade 18 cutting through the asphalt composite shingles, the user of cutting tool 10 will likely feel some of that vibration at the point where his or her hand holds onto cutting tool 10 at handle 22. Separating the head section 16, which in the preferred embodiment encloses or houses vibrating mechanism 20, will reduce the vibrations felt by the user. If desired, a vibration damping member 24 can be utilized to interconnect handle section 14 and head section 16 so as to further reduce the vibration felt by the user as he holds onto handle 22.

In the preferred embodiment, handle section 14 comprises a hand grippable, tubular handle 22 having a first end 26 and a second end 28 and head section 16 comprises a head body 30 configured with an internal chamber in which is positioned vibrating mechanism 20. As set forth in the embodiments shown in the figures, head body 30 of head section 16 connects to or is integral with the first end 26 of handle 22. For ease of use, it is preferred that the overall length of cutting tool 10 be approximately eight to ten inches and that handle 22 have a generally circular cross-section with a diameter of approximately one to three inches. As will be readily apparent to those skilled in the art, however, the invention is not so limited, as the cutting tool 10 can be of any size suitable for use to cut composite shingles and the cross-section of handle 22 can be square, rectangle, hexagon, octagon or various other shapes. Handle 22 and head body 30 can be manufactured from a variety of materials, including metal, plastics and suitable composites. The materials for cutting tool 10 should be selected with the knowledge that cutting tool 10 will be used by those in the roofing industry under somewhat difficult situations. As such, the materials for handle 22 and head body 30 should be as lightweight as possible yet durable, corrosion resistant and generally impact resistant. In addition, because the user of cutting tool 10 will usually be cutting roofing materials laying on a flat surface, it is preferred that the centerline of handle 22 be somewhat at an angle relative to a plane extending along the bottom of head body 30 (as shown in the figures), below which cutting blade 18 extends, for ease of cutting purposes. In a preferred configuration, this angle is approximately 20 to 30 degrees. With this configuration, the user will not have to tilt cutting tool 10 during use to cut composite shingles.

The cutting blade 18 of the embodiment shown in the figures is attached to the outer surface of head body 30 such that the cutting edge 32 of cutting blade 18 extends outwardly of head body 30 to cut the asphalt shingles. Although cutting blade 18 can have a single cutting edge 32, in the preferred embodiment, cutting blade 18 has two or more cutting edges, shown as 32a and 32b in FIG. 1 and 32a, 32b, 32c and 32d in FIG. 4 (collectively the cutting edges are referred to as cutting edge 32) for rearward cutting (i.e., pulling cutting tool 10 toward the user in the direction indicated as “R” on FIG. 1) or forward cutting (i.e., pushing the cutting tool 10 away from the user in the direction indicated as “F” on FIG. 2). As known in to those skilled in the art, some people in the roofing industry prefer to pull the composition knife or other prior art cutting device through the composition shingles and others prefer to push the knife to cut the shingles at the desired location. In the configuration shown in FIG. 1, with cutting edge 32a shown extending downward from head body 30, the cutting tool 10 is ready for rearward R or pulling use, whereas in the configuration shown in FIG. 2 the cutting edge 32b is for forward F or pushing use. In a preferred embodiment, shown in FIGS. 1 through 3, cutting edges 32a and 32b will be of the hooked type, such as the carbon hook utility blades from Irwin Industrial Tool Company (i.e., item number 2087100) or the large hook blade from Stanley Tools (i.e., product number 11-983). In an alternative embodiment, shown in FIG. 4, cutting blade 18 is of the notched, bow-tie type available from American Safety Razor Co. (i.e., model number MM0970-34). Although shown with the hook blade and the bow-tie blade in FIGS. 1 through 4, the invention is not so limited. As will be readily apparent to those skilled in the art, a straight edge blade or other configurations of cutting blade 18 can also be utilized with cutting tool 10 of the present invention to cut asphalt shingles. Preferably, which ever configuration of cutting blade 18 is utilized, the blade will preferably be of sufficient size to extend below head section 16 far enough to cut even the modern thicker composite shingles.

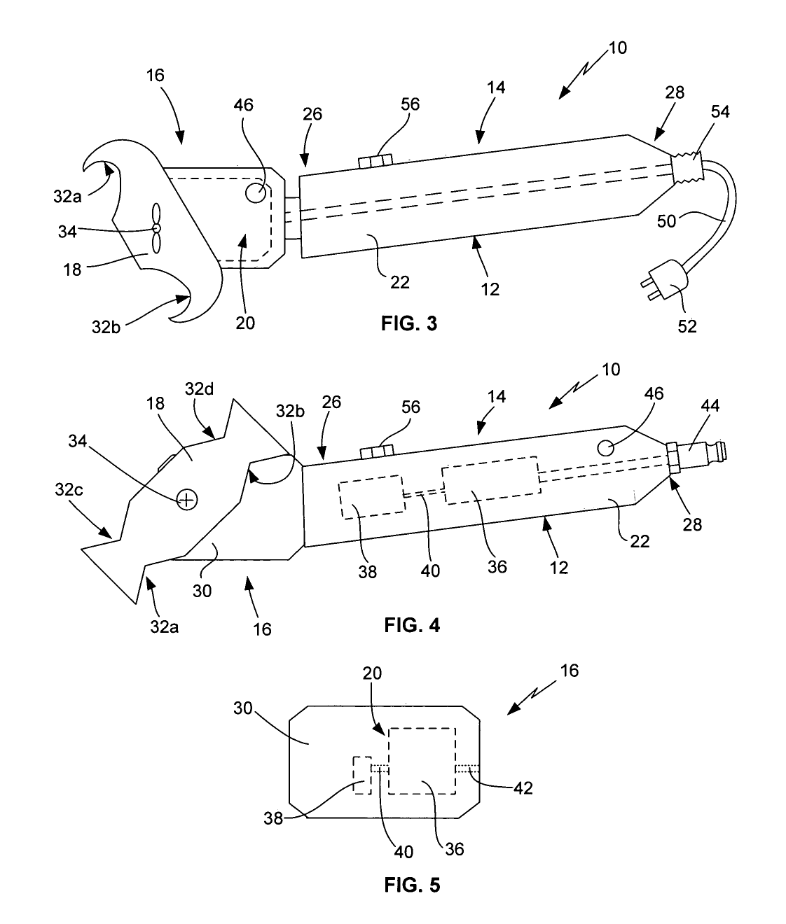

To facilitate the user selectively switching between the rearward R use of FIG. 1 and the forward F use of FIG. 2, it is preferred that cutting blade 18 be pivotally attached to head body 30 of head section 16. Preferably, cutting blade 18 is pivotally attached to head body 30 in a manner that allows the user to easily and quickly configure the cutting tool 10 for either rearward R or forward F cutting of the asphalt composite shingles. The head section 16 includes a connecting mechanism, shown as 34 in the figures, that connects the cutting blade 18 to head body 30 and securely holds it in position during use. Although the force required to be exerted by the user when utilizing cutting tool 10 will be somewhat less than with prior art devices, the connecting mechanism 34 must be able to effectively lock cutting blade 18 in the desired cutting position so as to prevent undesirable pivoting of cutting blade 18 during use. In the embodiments shown in FIGS. 1 and 2, the connecting mechanism is a phillips style screw. The embodiment shown in FIG.2 utilizes a standard hexagon nut and the embodiment of FIG. 3 utilizes a wing nut. The connecting mechanisms shown in these figures are merely intended to be exemplary of the different types of connecting means 34 that can be utilized for cutting tool 10 of the present invention. Numerous other types of connecting mechanisms 34, including some which may be more or less difficult and quick to operate than those shown, can also be utilized to allow the user to selectively pivot cutting blade 18.

In the various figures of the preferred embodiments of the cutting tool 10 of the present invention, cutting blade 18 is removably attached to the outside of head body 30 by one or more connecting mechanisms 34. Alternatively, though not shown in the figures, those skilled in the art will readily understand and appreciate that head body 30 can be configured such that cutting blade 18 is received in or through head body 30, such as in a channel, cavity or other location on head body 30, and be clamped or otherwise be securable in a non-moving manner. As with current box cutter types of composition knives, cutting tool 10 can be configured with cutting blade 18 being retractable such that it is received inside head body 30 when not in use. Although not shown, those skilled in the art will know that head section 16 can include an internal sliding mechanism having an external thumb or finger guide to direct the cutting blade 18 between the exposed, locked cutting position and the retracted, stored position. The key requirement with regard to the placement of cutting blade 18 on or in head body 30 is that the cutting edge 32 of cutting blade extend outward of head body 30 during use to cut the shingles and that cutting blade 18 be in or be suitable for secure, non-moving attachment to head body 30 during use so as to effectively cut the asphalt composition shingles and reduce the likelihood of injury to the user of cutting tool 10. Another key requirement for placement of cutting blade 18 is that it be relatively easily removed from cutting tool 18 for replacement when it becomes worn or damaged during use. In the preferred embodiment, as set forth above, cutting blade 18 should be able to pivot relative to head body 30 so as to allow the user to pivot or rotate the cutting edges 34.

The key improvement of cutting tool 10 of the present invention is the use of vibrating mechanism 20 to assist with the cutting of asphalt composition shingles by cutting blade 18. The present inventor has been in the roofing business for many years and has seen significant changes with regard to the composition shingles used for roofing. As set forth above, the materials utilized for composition shingles have changed and the shingles have gotten much thicker and, therefore, much harder to cut with the standard composition knife. Due to the difficulty of cutting the modern, thicker composition shingles, the inventor attempted to find an easier way to cut the composition shingles, but had little success until he developed the cutting tool 10 of the present invention with the vibrating mechanism 20. Identifying the benefit to cutting composite shingles by the addition of vibration to the cutting blade 18 significantly improved the ease and speed at which the shingles are cut, a result not expected by the inventor or by those skilled in the art of hand tools for roofing materials. The improvement in cutting shingles from the cutting tool 10 of the present invention applies to straight cuts and non-straight (i.e., curved or circular) cuts that are necessary to lay the shingles around roof projections and curved roof lines. The amount of vibration necessary to obtain the improvement of the present invention does not have to be significant. The inventor has found that the vibration imparted by other vibrating tools, such as a hand sander, is sufficient to vibrate the cutting blade 18 and improve the cutting of asphalt composition shingles.

As stated above, in the preferred embodiment of cutting tool 10 the vibrating mechanism 20 is disposed inside head body 30 of head section 16. Alternatively, as shown in FIG. 4, vibrating mechanism 20 can be incorporated into handle 22 of handle section 14. The use of vibration mechanism 20 to impart a vibration to a tool component is well known in the art and is commonly utilized in conjunction with other tools, most notably portable vibrating sanders, and with other non-construction devices, including muscle relaxing vibrators and back scratchers. Numerous configurations for vibrating mechanism 20 are suitable for use with cutting tool 10 of the present invention. As best shown in FIG. 5, such vibrating mechanisms 20 generally comprise a motor 36 that turns an eccentric weight 38 and a shaft 40 that interconnects the motor 36 and eccentric weight 38. As set forth in more detail below, a tubular channel or wire 42 connects to a source of power for motor 36. As the motor 36 rotates shaft 40 with eccentric weight 38 attached thereto, the imbalanced nature of rotating eccentric weight 38 will impart a vibratory force to cutting tool 10, preferably primarily just the head section 16, to vibrate cutting blade 18 and obtain the ease of cutting for the present invention.

Although various types of motors 36 may be suitable for use with cutting tool 10, the preferred motors 36 are of the pneumatic or electrical type due to the present use of such power sources in the roofing industry. Because many roofers currently utilize a pneumatic nail driving tool, it may be preferred to utilize a pneumatic motor 36 for cutting tool 10, as shown in FIGS. 1 and 4. In this manner, the compressed air supply line can connect to a Y connector at the user to divide the air line out to the currently used pneumatic nailer and to connect to a pneumatic connector 44 on the cutting tool 10 of the present invention. As shown in FIG. 1, pneumatic connector 44 can be located at the second end 28 of handle 22 with a pneumatic line or channel 46 inside handle 44 to connect to tube 42 and motor 36 so as to deliver compressed air to a rotor having air actuated blades or vanes. In the embodiment shown in FIG. 4, with motor 36 disposed inside the integral tool housing 12, the extra pneumatic line 46 may not be necessary. In either embodiment, it may be preferred to provide cutting tool 10 with an air regulating control mechanism 46 operatively connected to motor 36 so as to regulate the flow of compressed air to motor 36 in order to reduce or increase the vibration at cutting blade 18 so the user can have a smoother handling tool 10 or be able to cut thicker composition shingles. Control mechanism 46 is shown on head body 30 in FIG. 1 and on handle 22 in FIG. 4 so as to be more closely associated with motor 36.

In an alternative embodiment, motor 10 can be electric and powered by one or more rechargeable batteries 48, shown in FIG. 2, or a power cord 50, shown in FIG. 3, electrically connected to electric motor 36. Preferably, batteries 48 are of the rechargeable type so that the user can have a cordless cutting tool 10 that merely has to be recharged during non-use, as is common for many other tools in the roofing industry, as well as the construction industry in general. If batteries 48 are utilized for cutting tool 10, then it is preferred that the second end 28 of handle 22 be configured to be opened, either by unscrewing a cap at the end 28 or removing a door-like member so as to allow the user to remove batteries 48 from handle 22 for replacement as may be needed. If the electric motor 36 has power supplied through power cord 50, having a plug 52 at its distal end for plugging into a source of electricity (i.e., wall outlet or compressor), then batteries 48 become optional or even unnecessary. Preferably, the second end 28 of handle 22 in the embodiment of FIG. 3 is provided with a cord support member 54, commonly utilized with corded power tools, to prevent flexing of the power cord 50 resulting in damage to tool 10 or power cord 50.

In either the pneumatic or electric motor 36 embodiments, cutting tool 10 is preferably provided with an on/off switch 56 operatively connected to motor 36 to allow the user more control over the operation of cutting tool 10. The on/off switch 56 can be of the type that stays on when switch 56 is moved to the on position or it can be of the type that requires the user to maintain sufficient force against the switch 56 to keep it in the on position, so as to immediately shut off motor 36 when the force is released as a safety consideration, or a switch 56 can be a combination of the two. In the preferred embodiment, on/off switch 56 is located on handle 22 so that the user's thumb may easily reach it during use of cutting tool 10. Also in the preferred embodiment, handle 22 is covered with a rubber or like material to provide improved gripping, both from a comfort and a safety standpoint, of cutting tool 10 during use. Although handle 22 may be provided in a generally smooth configuration as shown in the figures, it may be preferred to provide a coarser surface and/or finger grips for even more improved gripping of cutting tool 10.

In use, the user selects whether he or she desires to have cutting blade 18 pivoted to the rearward R cutting direction or to the forward F cutting direction, as shown in FIGS. 1 and 2, respectively, and then connects cutting tool 10 to a source of pneumatic or electric power, as may be necessary. If provided, the cutting blade 18 is moved from its stored, retracted position to its operating, extended position. With cutting tool 10 connected to power and cutting blade 18 pivoted to the desired position, and locked into place on head section 16, the user then moves the on/off switch 56 to the “on” position so as to activate the pneumatic or electric motor 36 of the preferred embodiment of cutting tool 10 of the present invention. As a result of motor 36 rotating eccentric weight 38 via shaft 40 of vibrating mechanism 20, a vibration force will be imparted to cutting blade 28. The user then moves cutting blade 18 across the position on the composition shingle where he or she desires to make the cut with the cutting edge 32 against the composition shingle. The vibration of cutting blade 18 from vibration mechanism 20 will significantly reduce the amount of force that must be asserted by the user against the composition shingle, thereby easing and speeding up the cutting process. Once the user has cut the desired section of composition shingle, he or she moves the on/off switch to the “off” position and removes the cutting blade 18 from the composition shingle. If so provided, the user retracts the cutting blade into the head section 16 so as to prevent unintentional contact with cutting edge 32.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A shingle cutting tool, comprising:
a tool housing having a handle section and a head section;
a cutting blade attached to said tool housing, said cutting blade having one or more cutting edges; and
means associated with said tool housing for vibrating said cutting blade.

2. The cutting tool according to claim 1, wherein said cutting blade is attached to head section.

3. The cutting tool according to claim 2, wherein said cutting blade is pivotally attached to said head section.

4. The cutting tool according to claim 1, wherein said cutting edge of said cutting blade is selected from the group comprising a hooked blade and a notched blade.

5. The cutting tool according to claim 1, wherein said vibrating means is disposed in said tool housing.

6. The cutting tool according to claim 5, wherein said vibrating means is disposed in a head body in said head section.

7. The cutting tool according to claim 5, wherein said vibrating means is disposed in a handle in said handle section.

8. The cutting tool according to claim 1, wherein said vibrating means is pneumatically powered and said tool housing further comprises a pneumatic connector pneumatically connected to said vibrating means.

9. The cutting tool according to claim 1, wherein said vibrating means is electrically powered.

10. The cutting tool according to claim 9 further comprising one or more batteries disposed in said tool housing, said one or more batteries electrically connected to said vibrating means.

11. The cutting tool according to claim 10, wherein said one or more batteries are disposed in a handle of said handle section.

12. The cutting tool according to claim 1, wherein said head section and said handle section are integral.

13. A shingle cutting tool, comprising:
a tool housing having a handle and a head body, said handle having a first end and a second end, said head body at said first end of said handle;
a cutting blade pivotally attached to said head body, said cutting blade having one or more cutting edges; and
means disposed in said tool housing for vibrating said cutting blade.

14. The cutting tool according to claim 13, wherein said vibrating means is disposed in said head body.

15. The cutting tool according to claim 13, wherein said vibrating means is disposed in said handle.

16. The cutting tool according to claim 13, wherein said vibrating means is pneumatically powered and said tool housing further comprises a pneumatic connector pneumatically connected to said vibrating means.

17. The cutting tool according to claim 13, wherein said vibrating means is electrically powered.

18. The cutting tool according to claim 17 further comprising one or more batteries disposed in said tool housing, said one or more batteries electrically connected to said vibrating means.

19. The cutting tool according to claim 13, wherein said head body and said handle are integral.

20. A shingle cutting tool, comprising:
a tool housing having an elongated handle and a head body, said handle having a first end and a second end, said head body attached to said first end of said handle;
a cutting blade pivotally attached to said head body, said cutting blade having two more cutting edges, at least one of said cutting edges configured to cut in a rearward direction and at least one of said cutting edges configured to cut in a forward direction; and
means disposed in said tool housing for vibrating said cutting blade, said vibrating means comprising a motor, an eccentric weight and a shaft interconnecting said motor and said eccentric weight.
